(19) United States
(12) Patent Application Publication
(10) Pub. No.: US 2025/0093669 A1
(43) Pub. Date: Mar. 20, 2025

(54) ZERO POWER PUPIL RELAY

(71) Applicant: Meta Platforms Technologies, LLC, Menlo Park, CA (US)

(72) Inventor: Brandon Michael Hellman Friedman, Redmond, WA (US)

(21) Appl. No.: 18/887,653

(22) Filed: Sep. 17, 2024

Related U.S. Application Data
(60) Provisional application No. 63/583,869, filed on Sep. 20, 2023.

(51) Int. Cl. G02B 27/01; F21V 8/00; G02B 27/28

(52) U.S. Cl. CPC G02B 27/0179; G02B 6/0031; G02B 6/0055; G02B 27/0172; G02B 27/283

(57) ABSTRACT

The disclosed display system may include a projector including a light source configured to output light at an exit pupil, and a retroreflector configured to redirect the light from the exit pupil toward a relayed pupil. The display system may also include one or more beamsplitters, pupil steering elements, and/or waveguides. Various other methods, systems, and computer-readable media are also disclosed.

### CROSS REFERENCE TO RELATED APPLICATION

This application claims the benefit of U.S. Provisional Application No. 63/583,869, filed Sep. 20, 2023, the disclosures of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1A is an illustration of an example projector including a display and a lens.

FIG. 1B is an illustration of an example pupil relay including optics limited by etendue.

FIGS. 2A-C are illustrations of an example projector output having a virtual exit pupil.

FIGS. 3A-C are illustrations of examples of corner-cube retroreflectors.

FIG. 4 is an illustration of an example optical configuration (e.g., a pupil relay) including a retroreflector.

FIG. 5 is an illustration of an example optical configuration with an additional pupil steering element.

FIGS. 6A-B are illustrations of example pancake pupil relays.

FIG. 7 is an illustration of an example retroreflector surface in cross-section.

FIG. 8 is an illustration of an example augmented reality (AR) device having a pupil relay including a retroreflector.

FIGS. 9A-D are illustrations of example pupil relays including retroreflectors.

FIG. 10 is a flow diagram of an example method for using a zero power pupil relay.

FIG. 11 is an illustration of an example augmented-reality system according to some embodiments of this disclosure.

FIG. 12A is an illustration of an example virtual-reality system according to some embodiments of this disclosure.

FIG. 12B is an illustration of another perspective of the virtual-reality systems shown in FIG. 12A.

FIG. 13 is a block diagram showing system components of example artificial- and virtual-reality systems.

FIG. 14 an illustration of an example system that incorporates an eye-tracking subsystem capable of tracking a user's eye(s).

FIG. 15 is a more detailed illustration of various aspects of the eye-tracking subsystem illustrated in FIG. 14.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is directed to apparatus and methods relating to augmented reality and/or virtual reality (AR/VR) devices, which may include at least one of an augmented reality (AR), virtual reality (VR) and/or a mixed reality (MR) device. An example AR/VR device may include a display configured to provide virtual or augmented reality elements to the user at a location termed the eyebox. In augmented reality (AR), the AR image elements may be combined with light from an external environment. A user may view an image of the display using an optical configuration configured to form the image of the display within an eyebox. The term “eyebox” may refer to a volume in which the image is viewable by a user and may be located at or proximate, for example, eyepieces or viewing apertures.

A pupil relay may be used to extend the distance between the display and the eyebox. This allows additional flexibility in device design and may improve the image quality. Pupil relays may enable significant architectural gains in example AR/VR devices, such as improvements in one or more of form factor, optical efficiency, field of view, resolution, and/or other parameter(s).

Conventional pupil relays using multiple lens assemblies may introduce optical aberrations into the image and have excessive optical path length requirements that would degrade the form factor of the device. Conventional pupil relays have etendue, Lagrange invariant, and F-number limitations, so there are generally tradeoffs between size (e.g., track length, optical element diameter, weight), complexity (e.g., number of elements, special surfaces like aspheric or freeform surfaces with tougher fabrication and alignment tolerances), and performance (e.g., field of view, resolution, and the like). Conventional pupil relays add significant size, weight, and complexity to optical systems that are prohibitive in a compact light-weight AR/VR products.

In some examples, an AR/VR device may include a retroreflector and a beamsplitter configured to convey an image from a projector (e.g., a display and an associated lens assembly) to the eye of a user. In some examples, the retroreflector may include an arrangement of individual retroreflector elements (e.g., corner cubes, spherical elements, prisms, and/or other individual retroreflector elements) and the retroreflector may be curved so that incident light rays are reflected back along the same path (e.g., back along at least part of the incident light path) to a beamsplitter or polarized reflector. For example, individual retroreflector elements may be arranged in a curved arrangement, such as a portion of a spherical or non-spherical (e.g., parabolic or freeform) arrangement. A curved arrangement of individual retroreflectors (which may be termed a retroreflector for conciseness) may have no optical power, and a pupil relay including an arrangement of retroreflectors may be termed a zero power pupil relay.

A pupil plane may be defined as the plane in which chief rays cross the optical axis. For an example projector, the exit pupil may be real or virtual. A real or virtual exit pupil plane may be located by tracing chief rays output from the projector back to the optical axis. Some projectors may use scanning mirrors which act as pupil planes instead of a display.

In some examples, a display system (e.g., an AR/VR device) may include a projector having an exit pupil and being configured to output light, and a retroreflector. Light from the projector may be redirected by the retroreflector toward a relayed pupil. The light may be redirected toward a relayed pupil and may further be directed to a user's eye pupil, in some examples, being directed to a waveguide. The system may further include a beamsplitter, and the beamsplitter may be configured to redirect the light so the relayed pupil does not overlap the projector's exit pupil. The retroreflector may be curved or planar. In some examples, a retroreflector may be immersed (e.g., at least partially embedded in an optical medium such as an optical polymer or glass).

The projector may include a scanning projector or a display panel. A display panel may include a liquid crystal display (LCD). A display panel may include a backlit display and a backlight or an emissive display. In some examples, a display panel may refer to a reflective display such as a liquid crystal on silicon (LCoS) display. For example, a projector may include a pixelated display and associated projection optics. A retroreflector may include an array or other arrangement of corner cube elements, spherical elements, or other individual retroreflector elements.

Features from any of the embodiments described herein may be used in combination with one another in accordance with the general principles described herein. These and other embodiments, features, and advantages will be more fully understood upon reading the following detailed description in conjunction with the accompanying drawings and claims.

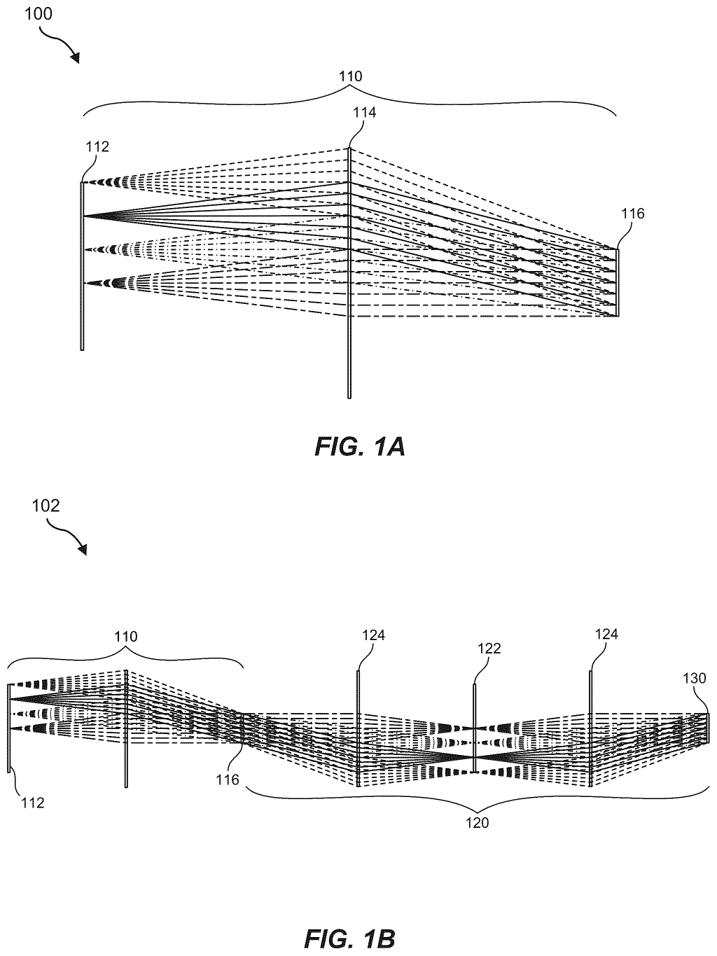

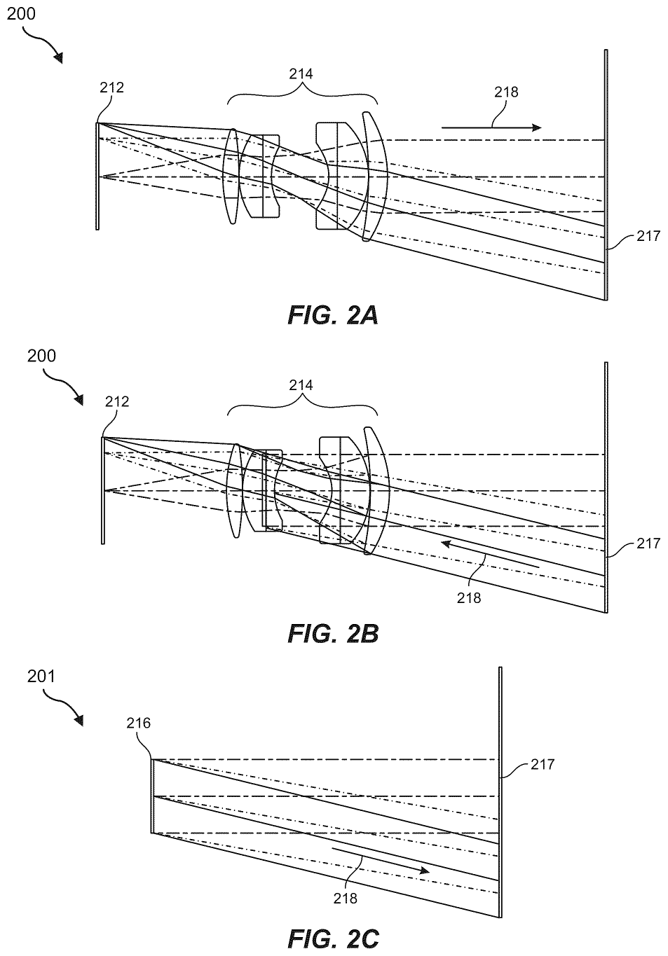

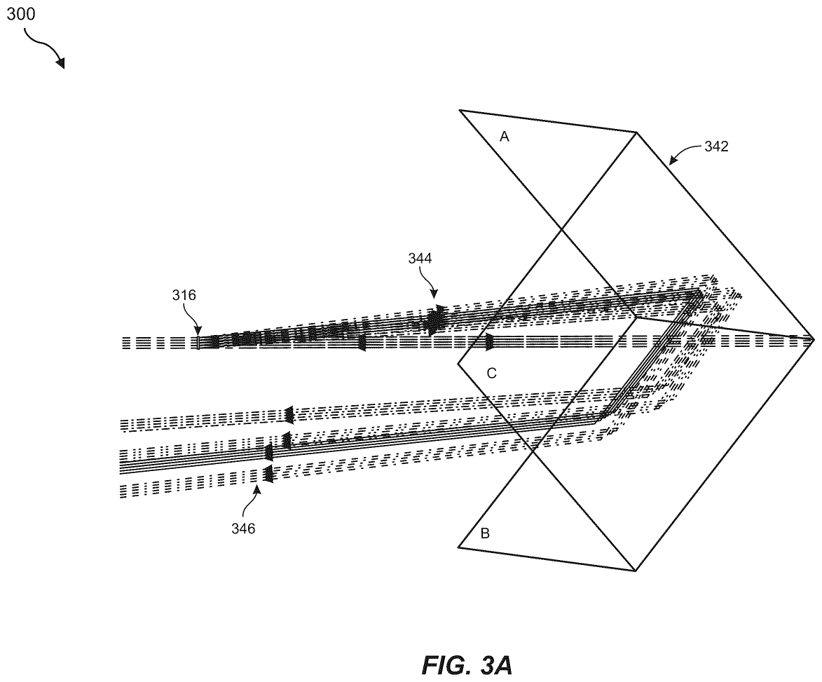

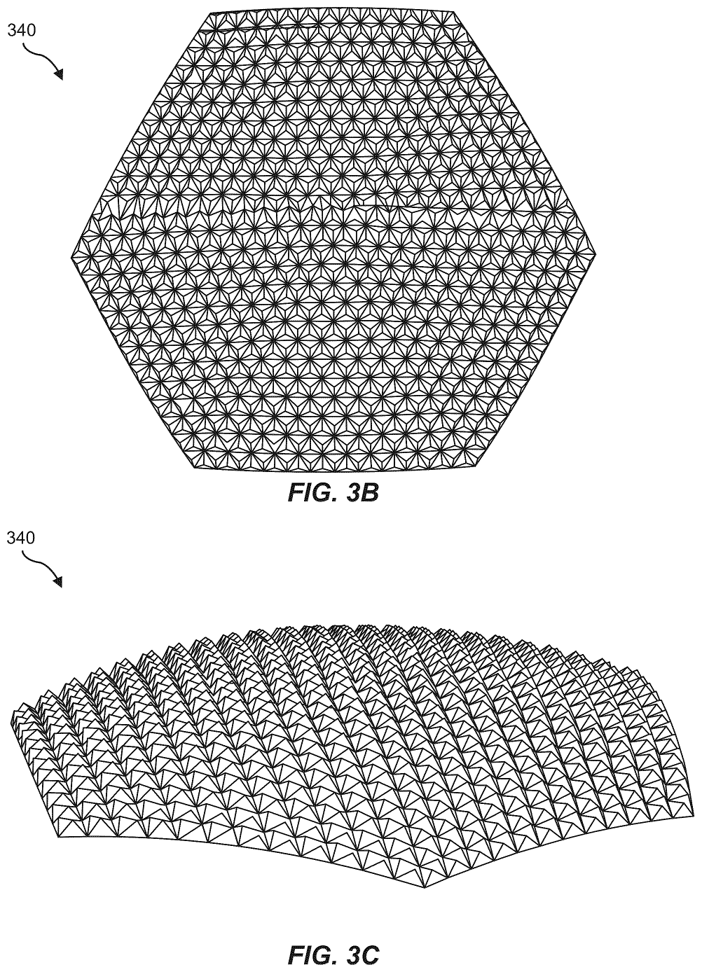

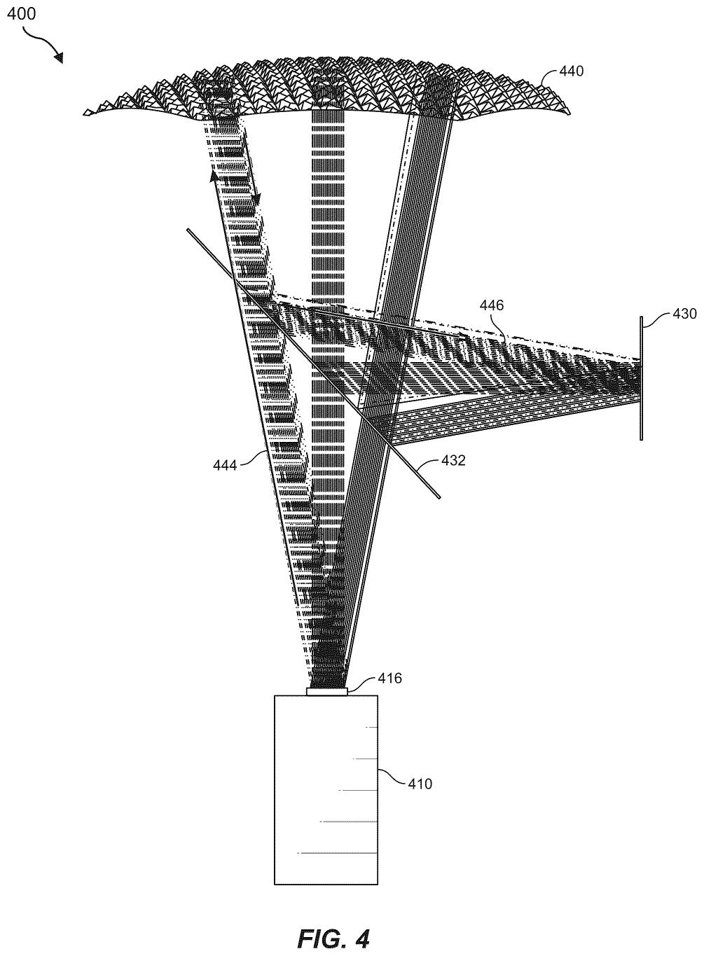

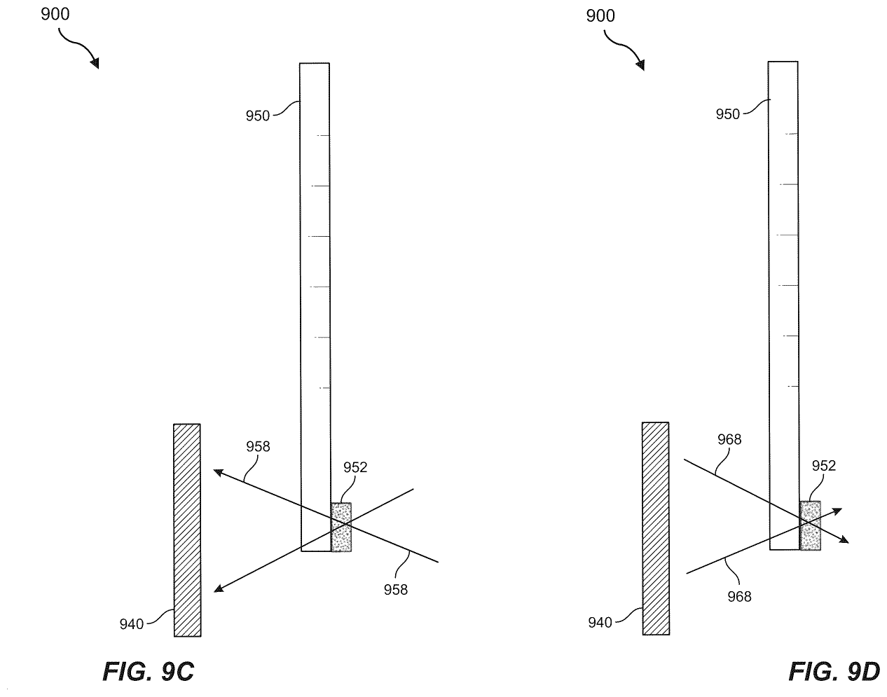

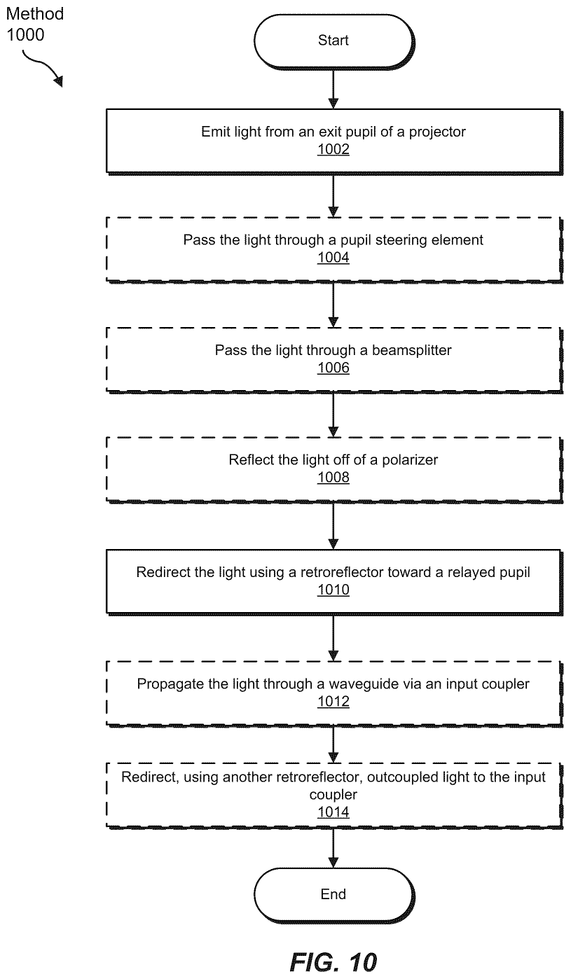

The following will provide, with reference to FIGS. 1A-15, detailed descriptions of zero power pupil relays. Detailed descriptions of example pupil relays will be provided in connection with FIGS. 1A-2C. Detailed descriptions of example retroreflectors will be provided in connection with FIGS. 3A-3C. Detailed descriptions of example zero power pupil relays will be provided in connection with FIGS. 4-9D. Detailed descriptions of an example method of using a zero power pupil relay will be provided in connection with FIG. 10. In addition, detailed descriptions of example AR/VR systems will be provided in connection with FIGS. 11-15.

FIG. 1A illustrates a diagram of an example projector display device 100 including a projector 110 that includes a light source 112, a lens 114, and an exit pupil 116. Light source 112 may correspond to a display or otherwise an object (e.g., the observed light source) for outputting one or more wavelengths of light (e.g., visible light) in configurable arrangements so as to form an image perceptible to a user's eye. For example, light source 112 may correspond to any display device and/or portion thereof (e.g., including another projector) such as one or more liquid-crystal displays (LCDs), light emitting diode (LED) displays, organic LED (OLED) displays, and/or any other suitable types of display screens, scanning mirrors, etc. Further, light source 112 may correspond to an image plane (e.g., an optical plane in which an image of the object may be formed by light). Lens 114 may correspond to any transmissive optical device for focusing and/or dispersing light beams, such as through refraction. Exit pupil 116 may correspond to other otherwise be referred to a projector output pupil (plane). A pupil plane may correspond to where chief rays (e.g., radiating out from light source 112) may cross an optical axis, forming an image. In FIG. 1A, the pupil plane (e.g., exit pupil 116) may be real or virtual, which may be located by tracing the chief rays output from projector 110 back to the optical axis (e.g., light source 112).

As illustrated in FIG. 1, a particular configuration for lens 114 may result in a particular location for exit pupil 116, which may correspond to a preferred location for the user's eye or eyebox. A pupil relay may be used to extend the distance between the display and the image location (e.g., allowing a different desired location for the eyebox).

FIG. 1B illustrates a diagram of an example projector display device 102 including the projector 110 coupled to a pupil relay 120 which may include conventional optics (e.g., optics limited by etendue). Pupil relay 120 may include an intermediate image 122, one or more lenses 124, and a relayed pupil 130. Pupil relay 120 may require formation of an intermediate image plane (e.g., intermediate image 122). Accordingly, pupil relay 120 may require a very long track length and/or have many optical surfaces to correct aberrations, which may restrict incorporation of pupil relay 120 into various device configurations and/or form factors.

FIG. 2A-2B illustrate diagrams of projector output of an example projector device 200 (corresponding to, for example, projector display device 100), having a display 212 (corresponding to light source 112 and/or projector 110), a lens arrangement 214 (e.g., comprising multiple lenses and corresponding to lens 124), and further having a projector output of a virtual exit pupil 217. FIG. 2C illustrates a diagram 201 having lens arrangement 214 omitted to more clearly illustrate an exit pupil 216.

Output light rays 218 (e.g., chief rays) may not cross the optical axis after the final element of lens arrangement 214, resulting in virtual exit pupil 217. In FIG. 2B, the chief rays (e.g., output light rays 218) may be traced back to find the exit pupil plane (e.g., exit pupil 216). However, pupil relay, as described herein, may relay a virtual exit pupil.

In some examples, a pupil relay as described herein may comprise or otherwise use a retroreflector having zero optical power. FIGS. 3A-3C illustrate examples of retroreflectors.

An individual retroreflector element may include a shaped element (e.g., a cube, cuboid, sphere or spheroid) or may include a depression formed in a substrate (e.g., a corner cube or hemispherical depression). A shaped element or spheroid may include at least one of a glass, a polymer, or a semiconductor. A retroreflector element may include a reflective (e.g., a mirror), partially reflective (e.g., a beamsplitter) or polarized reflective layer. A beamsplitter may reflect a portion of incident light intensity (e.g., 30%-70%) and transmit the remainder. A mirror may reflect at least 80% of the incident light intensity, such as at least 90%. A polarized reflective layer may reflect one polarization of incident light and transmit the other polarization, for example, reflecting at least 70% of a first polarization and transmitting at least 70% of the other polarization. A reflective layer may include at least one of a metal film (e.g., aluminum, gold, silver, or any other metal or alloy), Bragg grating, arrangement of nanostructures (e.g., nanowires), or other optical layer or multilayer. The optical properties described may be for at least one wavelength of incident light, such as at least one visible wavelength.

FIG. 3A illustrates an example retroreflector 300 including a single corner cube retroreflector 342. A retroreflector may maintain the angle of a light ray, but upon reflection reverses the direction of propagation. For example, light beam from a starting output pupil 316, in a propagation direction 344 (e.g., to the right in FIG. 3A as indicated by the arrows) may be retroreflected by corner cube retroreflector 342 as retroreflected beams 346, which in some examples may be non-converging to one another so as to not relay to a real pupil.

As illustrated in FIG. 3A, a corner cube retroreflector element (e.g., corner cube retroreflector 342) may include three orthogonal reflecting facets (e.g., three reflective surfaces configured to be 90 degrees to one another). An example tolerance on the facet orthogonality (i.e., tolerance on the angle between facets, or equivalently the error or deviation from 90 degrees between surface facets) may be half the reflection error and propagate across the three surfaces reflections. A corner cube may have three surfaces denoted A, B, and C. The orthogonal error between surfaces (deviation from 90 degrees) A and B is Δθ_AB, B and C is Δθ_BC, C and A is Δθ_CA. Retroreflection error is Δθ_RR=2(Δθ_AB+Δθ_BC+Δθ_CA). Thus, if 10 arc min imaging resolution is required, allowing +/−5 arc min retroreflection error, then Δθ_RR≤5 arc min, and the sum of the orthogonality error of all three surfaces may be less than or equal to 2.5 arc min: Δθ_AB+Δθ_BC+Δθ_CA≤2.5 arc min in some examples.

If the corner cube retroreflections happen in glass (e.g., as opposed to in air), these tolerances are modified by the refractive index and particular geometry including the refraction back to air after retroreflection.

Diffraction optics considerations may suggest further optical design and fabrication tolerances for retroreflectors within an imaging optical system. The angular resolution limit due to diffraction of light propagating through an aperture may be described by: Δθ_diff=2.44λ/d, where λ is the wavelength and d is the aperture size. Resolution through each retroreflector element must be preserved to the requirement of the imaging system, so in this case d is the diameter of a retroreflector element, d_element.

For example, if a 10 arc min resolution is required using a wavelength of 550 nm, then 2.44*550 nm/d_element ≤10 arc min, so after converting 10 arc min to radians, d_element≥461 microns.

The geometry of the retroreflector element may impact the diffraction limit. For instance, the edges between the facets of a retroreflecting corner cube may further degrade the diffraction resolution limit, whereas a retroreflecting sphere may not.

In some examples, the spatial offset between incident and reflected rays from a single retroreflector may be as large as the size of the retroreflector. Hence, it may be advantageous to use a retroreflector including an arrangement of individual retroreflector elements rather than a single large retroreflector. In some examples, a retroreflector may include at least 20 individual retroreflector elements, such as at least 40 elements, and in some examples at least 80 elements. Using a retroreflector may ensure that a real pupil is formed (or roughly formed).

FIGS. 3B and 3C illustrate examples of multi-element arrangements of corner-cube retroreflectors. Example retroreflector elements may include a plurality of individual retroreflector elements arranged in a planar or curved arrangement. Individual retroreflector elements may be in an array or otherwise arranged. Individual corner-cube retroreflectors may include planar surfaces that have no inherent optical power. For example, a corner-cube retroreflector may include three orthogonal plane reflective surfaces that define a cube corner.

Individual retroreflector elements may include corner cubes or reflecting spheres, which may repeat as same elements, different elements, different sizes/dimension, etc. In addition, array structures may also vary. In some examples, a triangular array may allow for curving the array while maintaining uniformity. FIGS. 3B and 3C illustrate a retroreflector 340 comprising, for example, a triangular array of corner cubes in a curved arrangement. FIG. 3B illustrates a top-down view of retroreflector 340 and FIG. 3C illustrates a slanted side view of retroreflector 340.

If a light ray is incident at too steep an angle to a retroreflector element, particularly at the edges of the retroreflector aperture, the ray may not retroreflect correctly (e.g., it may only hit two surfaces of the corner cube instead of all three). Curving the retroreflector about the initial pupil may reduce the angle of incidence of light onto each retroreflector element. Accordingly, a retroreflector may have a retroreflecting concave surface including an arrangement of individual retroreflector elements, as in FIGS. 3B and 3C. The retroreflecting concave surface of the retroreflector may have a radius of curvature approximately equal in magnitude to the distance between the relayed pupil and the retroreflecting concave surface.

The relayed pupil from a retroreflector may become more homogenous and similar to the original pupil as the retroreflector element pitch is reduced, for example, using smaller and/or more individual retroreflector elements. In general, the relayed pupil may increase in diameter by about twice the diameter of the individual retroreflector elements (e.g., corner cubes, spherical elements, or other individual retroreflector elements). While smaller elements may preserve the relayed pupil quality, in some examples, fabrication challenges to smaller retroreflector elements and resolution tradeoffs as the small size of the individual elements may impede imaging resolution due to diffraction. In some examples, a corner cube may have an edge length of between 50 microns and 1 mm, such as between 100 microns and 1 mm. In some examples, a spheroidal (e.g., spherical) retroreflecting element may have a diameter in the range of between 50 microns and 1 mm, such as between 100 microns and 1 mm. In some examples, a diameter or diagonal of an individual retroreflecting element may be in the range 200 microns-800 microns.

Geometrical optics considerations may lead to the following design parameters. Individual retroreflector elements may retroreflect within ½ the resolution requirement of the imaging system. For example, if the imaging system has a 10 arc min (1 deg=60 arc minutes) resolution requirement, the retroreflector elements may be designed to retroreflect within 5 arc min (e.g., retroreflection with +/−5 arc min from nominal preserves 10 arc min imaging resolution).

Further, in some examples, the retroreflector may be fabricated to tolerances that preserve imaging resolution. A retroreflector may be located in an imaging optical system between the projector and the output pupil, as will be described further below. A projector may include a 2D scanning mirror, projected display panel, or other arrangement. Resolution may be maintained according to geometrical and diffractive optics considerations.

In yet other examples, polarization correction for use with a polarization based beamsplitter can be implemented, for example, using a waveplate or spatially modulated waveplate overlaid on the array as will be described further below. In some examples, a device may include at least one optical retarder, such as a quarter-wave or half-wave retarder.

In some examples, a retroreflector having zero optical power may be used as a pupil relay. Although the examples herein refer to a retroreflector comprising a curved array of corner cubes (e.g., retroreflector 340), in other examples, other retroreflector arrangements may be used. A beamsplitter may be used to separate the original pupil and the relayed pupil. The retroreflector may be curved to maintain normal incidence of light onto each retroreflector element, which maintains retroreflector efficacy as described above. However, a curved retroreflector may not have optical power (e.g., individual retroreflector elements may include corner cubes without curved surfaces having optical power). In some examples, all optical power may be associated with elements upstream from the original pupil, which may allow much smaller elements to be used. Additional polarization and/or coatings and/or phase or wave plates may be used for beam control, which may be handled, for example, through the beamsplitter. In some examples, the retroreflector surface may be immersed, as will be described further below. In this context, an immersed surface may be located within or adjacent an optical material, typically a solid such as an optical polymer or glass.

Turning now to FIG. 4, FIG. 4 illustrates a pupil relay device 400 corresponding to an example optical configuration including a retroreflector, which in some implementations may be used in a VR device. Pupil relay device 400 may include a retroreflector 440 (corresponding to a curved retroreflector such as retroreflector 340), a projector 410 (corresponding to projector 110) having an exit pupil 416 (corresponding to exit pupil 116), a beamsplitter 432 (e.g., corresponding to any beamsplitter device and/or arrangement), and a relayed pupil 430 (corresponding to relayed pupil 130).

As illustrated in FIG. 4, light from exit pupil 416, traveling in a direction of light propagation 444, may be relayed (e.g., reflected/retroreflected) by retroreflector 440 to beamsplitter 432. Beamsplitter 432 may be located between an original pupil (e.g., exit pupil 416) and retroreflector 440 and may be configured to redirect retroreflected beams 446 to a second exit pupil (e.g., relayed pupil 430) which may be located at the user's eyebox. Accordingly, retroreflector 440 may be configured to redirect the light from the exit pupil and (directly and/or indirectly through one or more optical elements describe herein) toward relayed pupil 430. In addition, beamsplitter 432 may accordingly be configured to further redirect (e.g., directly and/or indirectly through one or more optical elements describe herein) the light reflected by retroreflector 440 such that relayed pupil 430 is separate from exit pupil 416.

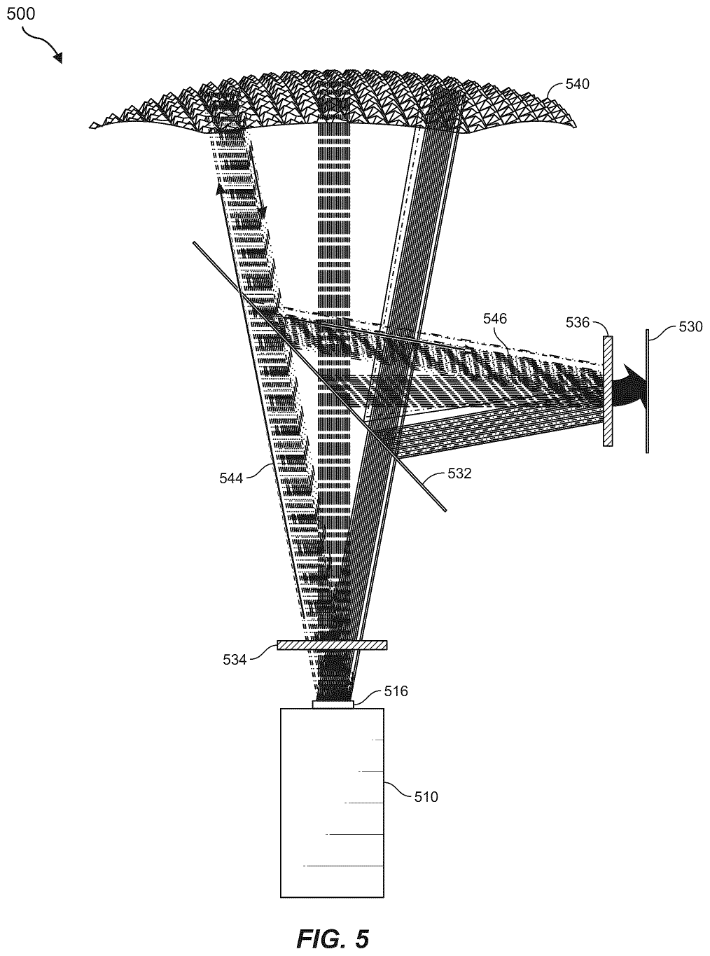

FIG. 5 shows a configuration similar to FIG. 4 with additional pupil steering elements. FIG. 5 illustrates a pupil relay device 500 (corresponding to pupil relay device 400), which in some implementations may be used in a VR device. Pupil relay device 500 may include a retroreflector 540 (corresponding to a curved retroreflector such as retroreflector 340), a projector 510 (corresponding to projector 110) having an exit pupil 516 (corresponding to exit pupil 116), a beamsplitter 532 (e.g., corresponding to any beamsplitter device and/or arrangement such as beamsplitter 432), and a relayed pupil 530 (corresponding to relayed pupil 130). FIG. 5 also includes a pupil steering element 534 and a pupil steering element 536, each of which may correspond to any optical element and/or arrangements of optical elements that may change incident light angle and may be used for pupil steering (e.g., in conjunction with eye-tracking systems described further herein).

The pupil steering elements (e.g., pupil steering element 534 and/or pupil steering element 536) may be configured to steer the relayed pupil spatially within the eyebox corresponding to relayed pupil 530, as indicated by the thick arrow after pupil steering element 536. The pupil steering elements may be located before retroreflection (e.g., pupil steering element 534) and/or after retroreflection (e.g., pupil steering element 536). In other examples, a fewer and/or greater number of pupil steering elements may be used, which may be in other locations. For example, a pupil steering element may also be located before the pupil of projector (e.g., exit pupil 516), which may allow steering about the curvature of the eyeball.

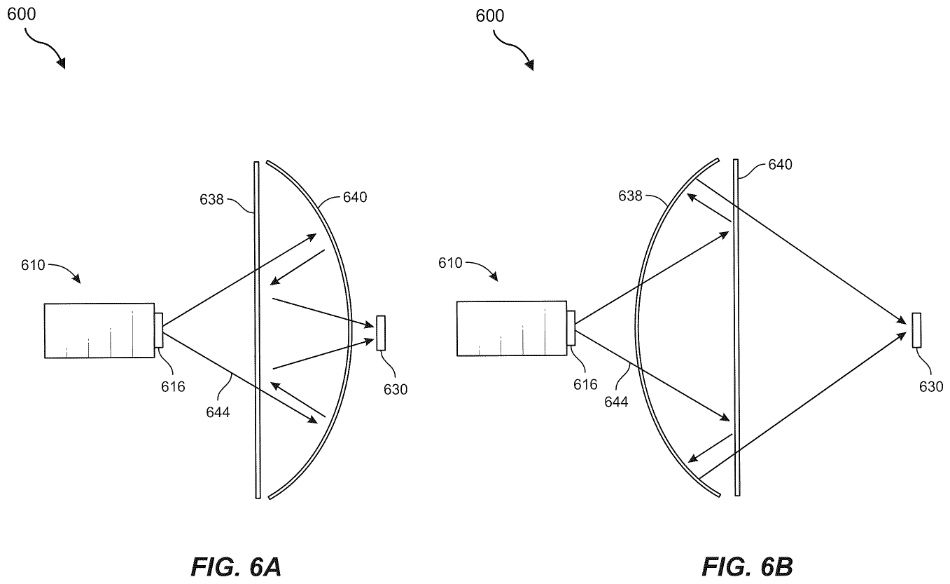

FIGS. 6A and 6B illustrate an example pancake pupil relay device 600, in some implementations may be used in a VR/AR device. Pancake pupil relay device 600 may include a retroreflector 640 (corresponding to a curved retroreflector such as retroreflector 340), a projector 610 (corresponding to projector 110) having an exit pupil 616 (corresponding to exit pupil 116), a mirror 638 (e.g., corresponding to any reflective surface such as a polarized reflector, a beamsplitter, etc.), and a relayed pupil 630 (corresponding to relayed pupil 130).

A pancake configuration may include one or more reflections. For example, a light path 644 may include a reflection back towards the display (e.g., projector 610) followed by a second reflection towards a direction away from the display, as indicated by the arrows in FIGS. 6A and 6B. A pancake lens may provide light polarization (e.g., in conjunction with a polarized reflector such as mirror 638) to help fold the optical path. This allows a reduced total track length (e.g., between the display represented by exit pupil 616 and the eyebox represented by relayed pupil 630) while maintaining a single optical axis (e.g., having rotational symmetry and avoiding non-symmetric folding). Example optical configurations may provide light reflections on a 50/50 mirror (also termed a beamsplitter) and a reflective polarizer. A reflective polarizer may be configured to transmit a first polarization of light and reflect a second polarization of light. For example, the polarizations of light may include linear polarizations and/or circular polarizations. In some examples, a display panel may emit polarized light such as linearly or circularly polarized light. In some examples, reflections (e.g., from a retroreflector or beamsplitter) or an optical retarder may be used to change the polarization state of light to achieve a desired performance of a reflective polarizer.

A retroreflector (e.g., retroreflector 640) may or may not support polarization-sensitive coatings (e.g., a reflective polarizer). In some examples, retroreflector 640 may support a beamsplitter (e.g., a 50/50 mirror). In some examples, retroreflector 640 may support a coating layer to smooth (e.g., planarize or to otherwise smooth) the retroreflector surface, and a reflective polarizer or a beamsplitter may be supported on the coating layer. Additional polarization control components may include one or more of each of the following: quarter wave plates, linear polarizers, reflective polarizers, beamsplitters (e.g., 50/50 mirrors), and the like.

FIG. 6A shows an optical configuration in which the display light (indicated by light path 644) passes through the beamsplitter (or, in some examples, a reflective polarizer) represented by mirror 638, is redirected back along part of the incident light path by retroreflector 640, and is then reflected by the beamsplitter (or, in some examples, a reflective polarizer) to form relayed pupil 630. Retroreflector 640 may be curved, and in some examples may provide a concave retroreflective surface.

FIG. 6B shows a further example optical configuration in which the display light (indicated by light path 644) passes through retroreflector 640 (e.g., being configured as a beamsplitter and/or, in some examples, a reflective polarizer), is redirected back along part of the incident light path by mirror 638 (e.g., a beamsplitter and/or polarized reflector), and is then reflected by retroreflector 640 through mirror 638 to form relayed pupil 630. Retroreflector 640 may be curved, and in some examples may provide a concave retroreflective surface.

In some examples, the configuration(s) of FIGS. 6A and/or 6B may include one or more pupil steering elements located before or after the retroreflector. In this context, “before” may refer to being within an optical path between the display (e.g., projector 610) and the retroreflector (e.g., retroreflector 640), and “after” may refer to being within an optical path between the retroreflector (e.g., retroreflector 640) and the eyebox (e.g., relayed pupil 630).

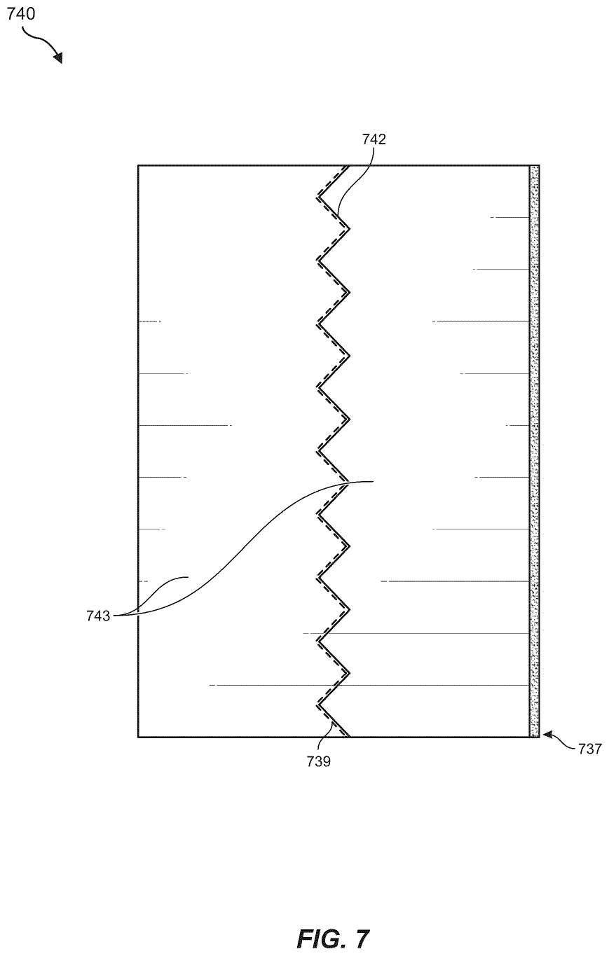

FIG. 7 illustrates an example retroreflector 740 (corresponding to retroreflector 340 and more specifically retroreflector 640) and more specifically a retroreflector surface in cross-section and having an array of corner cube retroreflector element(s) 742 (e.g., corresponding to corner cube retroreflector 342 and illustrated as a 2-D cross-section) having a coating 739 and sandwiched between material 743, and further having a coating stack 737. Retroreflector 740 may correspond to an immersed surface (e.g., the array of corner cube retroreflector elements 742 being embedded in an optical element made of material 743), allowing the pancake pupil relay (e.g., pancake pupil relay device 600) to be fabricated into a monolithic element. A retroreflective surface may be fabricated using methods such as diamond turning or injection molding the element containing the retroreflector surfaces, then applying any desired coating(s) (e.g., coating 739 which may correspond to a 50/50 mirror and/or other desired coating), then applying a secondary element if desired by an adhesive process (e.g., coating stack 737 which may correspond to a reflective polarizer and/or other desired element). Materials 743 of the two sides may or may not be the same. A monolithic architecture may have optical performance benefits such as increased contrast due to fewer ghost surfaces. A coating material (e.g., coating 739) may also be used to protect retroreflector surfaces (e.g., from mechanical or chemical damage).

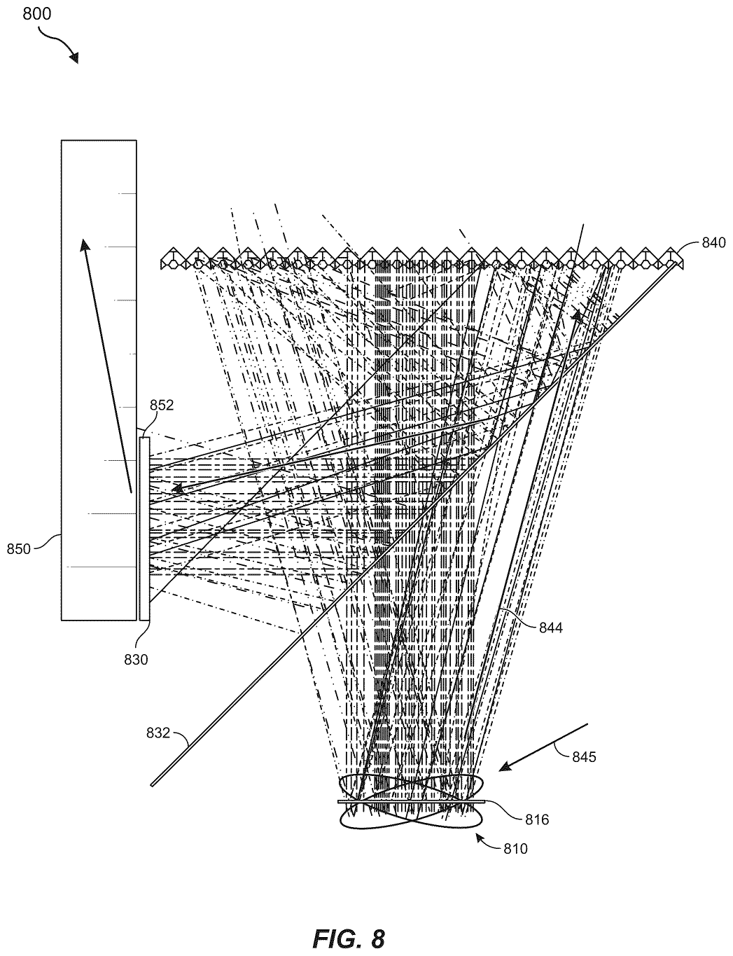

FIG. 8 illustrates a pupil relay device 800 corresponding to an example optical configuration including a retroreflector, which in some implementations may be used in an AR device. Pupil relay device 800 may include a retroreflector 840 (corresponding to a retroreflector such as retroreflector 340 although other shapes may be used), a 2D scanning mirror 810 (corresponding to projector 110) having an exit pupil 816 (corresponding to exit pupil 116), a beamsplitter 832 (e.g., corresponding to beamsplitter 432), and a relayed pupil 830 (corresponding to relayed pupil 130).

As illustrated in FIG. 8, collimated light 845 from 2D scanning mirror 810 may be coupled into a waveguide 850 (corresponding to any appropriate waveguide device and/or arrangement) through an input coupler 852 which may correspond to relayed pupil 830 (e.g., relayed pupil 830 being configured at input coupler 852). Without a pupil relay, the footprint of light on input coupler 852 may be much larger than the area of 2D scanning mirror 810 acting as exit pupil 816, and the larger input coupling area may, in some examples, lead to lower optical efficiency. In addition, a pupil relay including an arrangement of lenses (e.g., as in FIG. 1B, 2A, and/or 2B) may be too large for an AR application (e.g., lacking space within an AR device form factor for such a pupil relay). FIG. 8 shows a compact pupil relay arrangement including retroreflector 840, which in some examples may be a flat or a curved array. Light, as indicated by a direction of light propagation 844 (further indicated by arrows), may travel from 2D scanning mirror 810, through beamsplitter 832, retroreflected (and/or reflector or otherwise directed) by retroreflector 840 to beamsplitter 832, further reflected and/or otherwise directed by beamsplitter 832 to waveguide 850 (e.g., more specifically to input coupler 852), and propagated through waveguide 850.

Pupil relay device 800 may be relatively compact (e.g., as compared to the arrangements in FIG. 1B, 2A, and/or 2B) and may form relayed pupil 830 within an area similar to the area of 2D scanning mirror 810, which may lead to higher coupling and waveguide efficiency.

In some examples, a display system may include a projector outputting light (e.g., a projector including a light source such as a display), a waveguide having an input coupler and output coupler, and a retroreflector. Light from the projector may propagate through the input coupler of the waveguide to form coupled light and uncoupled light. The retroreflector may be positioned after the waveguide, so the uncoupled light propagates through the waveguide input coupler to become coupled-uncoupled light and uncoupled-uncoupled light, where the coupled light and the coupled-uncoupled light propagate within the waveguide to the output coupler. Light may make a plurality of passes through the input coupler of the waveguide to increase coupling efficiency.

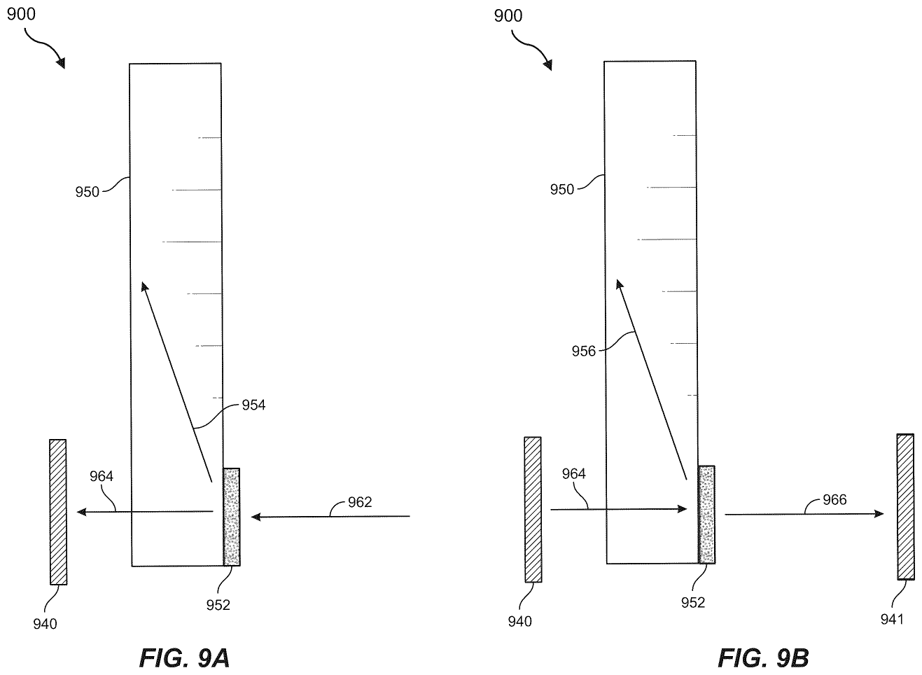

FIGS. 9A-9D illustrate diagrams of another example pupil relay device 900 corresponding to an example optical configuration including a retroreflector and configured for input coupler light recycling, which in some implementations may be used in an AR device. Pupil relay device 900 may include a retroreflector 940 (corresponding to a retroreflector such as retroreflector 340 although other shapes may be used), and a waveguide 950 (corresponding to waveguide 850) having an input coupler 952 (corresponding to input coupler 852).

FIG. 9A shows light 962 (e.g., from a display such as projector 110) projected toward input coupler 952 that may in-couple some light (e.g., in-coupled light 954). Un-coupled light 964 may pass through input coupler 952. FIG. 9B shows retroreflector 940 used to reflect un-coupled light 964 (in FIG. 9A) back (as retroreflected un-coupled light 964) to input coupler 952 for a second pass to in-couple some of the light that was un-coupled in the first pass (e.g., as coupled-uncoupled light 956). An additional retroreflector 941 may be used for additional passes of the uncoupled light (e.g., uncoupled light 966) through input coupler 952. In some implementations, an optical cavity may be formed between the two retroreflectors (e.g., retroreflector 940 and retroreflector 941) for more than two passes of light through input coupler 952.

FIGS. 9C-9D further illustrate pupil relay device 900. FIG. 9C illustrates a first pass 958 of light through input coupler 952. FIG. 9D illustrates a second pass 968 of light (as retroreflected by retroreflector 940) though input coupler 952. In some examples, a retroreflector (e.g., retroreflector 940 and/or retroreflector 941) may provide advantages over planar flat mirrors because the pupil size may be maintained (or maintained with marginal increases such as less than 20% additional area), which may advantageous for input coupler efficiency and waveguide optical efficiency.

FIG. 10 is a flow diagram of an exemplary method 1000 for using a zero power pupil relay. The steps shown in FIG. 10 may be performed by any suitable device and/or system, including the system(s) illustrated in FIGS. 4, 5, 6A-6B, 7, 8, and/or 9A-9D and/or combinations thereof, which also may be controlled by a controller, processor, etc. as part of a display device further described below. In one example, each of the steps shown in FIG. 10 may represent an algorithm whose structure includes and/or is represented by multiple sub-steps, examples of which will be provided in greater detail below.

As illustrated in FIG. 10 at step 1002 one or more of the systems described herein may emit light from an exit pupil of a projector. For example, a projector (e.g., projector 410, projector 510, projector 610, and/or 2D scanning mirror 810) may emit light (e.g., light 444, light 544, light 644, light 844, and/or light 962) from an exit pupil (e.g., exit pupil 416, exit pupil 516, exit pupil 616, and/or exit pupil 816).

Optionally, at step 1004 one or more of the systems described herein may pass the light through a pupil steering element. For example, the light may be passed through pupil steering element 534 and/or pupil steering element 536.

Optionally, at step 1006 one or more of the systems described herein may pass the light through a beamsplitter. For example, light may be passed through beamsplitter 432, beamsplitter 532, and/or beamsplitter 832.

Optionally, at step 1008 one or more of the systems described herein may reflect the light off of a polarizer. For example, light may be reflected off of mirror 638, coating 739, and/or coating stack 737.

At step 1010 one or more of the systems described herein may redirect the light using a retroreflector toward a relayed pupil. For example, retroreflector 440, retroreflector 540, retroreflector 640, retroreflector element 742, retroreflector 840, retroreflector 940 and/or retroreflector 941 may redirect (e.g., directly and/or indirectly reflect/retroreflect) the light toward relayed pupil 430, relayed pupil 530, relayed pupil 630, relayed pupil 830 (e.g., input coupler 852) and/or input coupler 932.

Optionally, at step 1012 one or more of the systems described herein may propagate the light through a waveguide via an input coupler. For example, light may propagate through waveguide 850 via input coupler 852, and/or through waveguide 950 via input coupler 952.

Optionally, at step 1014 one or more of the systems described herein may redirect, using another retroreflector, outcoupled light to the input coupler. For example, another pass of light (e.g., un-coupled light 964 and/or second pass 968) may be directly and/or indirectly redirected by a retroreflector (e.g., retroreflector 941) to the input coupler (e.g., input coupler 952).

As detailed above, a zero power pupil relay may include one or more retroreflector elements (e.g., in an array). An example method may include emitting light from a display, reflecting the light from a retroreflector, and directing the light to an eyebox of an AR/VR device. Emitting light may include emitting polarized light, such as linearly or circularly polarized light. The emitted light may be controlled by a controller and may include image or video representations.

Example methods may include computer-implemented methods for operating or fabricating an apparatus, such as an apparatus as described herein. For example, a computer-implemented method may include controlling the stamping, molding, or other processes used to form a retroreflector. A retroreflector may include an arrangement of individual retroreflective elements (e.g., an arrangement of cubes, spheres or indentations formed in a substrate). A method may further include fabricating an optical system including a display assembly, a retroreflector, and optionally at least one of a reflector, beamsplitter, or polarized reflector. The steps of an example method, such as adhering components together, may be performed by any suitable computer-executable code and/or computing system. For example, a method may include displaying an image on a display and forming an image viewable by a user at least in part by directing light emitted by the display using a retroreflector. In some examples, one or more of the steps of an example method may represent an algorithm whose structure includes and/or may be represented by multiple sub-steps. In some examples, a method for assembling an optical device such as an AR/VR device may include computer control of an apparatus such as a molding, stamping or coating apparatus.

In some examples, an apparatus may include at least one physical processor and physical memory including computer-executable instructions that, when executed by the physical processor, cause the physical processor to control an apparatus, for example, using a method such as described herein.

In some examples, a non-transitory computer-readable medium may include one or more computer-executable instructions that, when executed by at least one processor of an apparatus, cause the apparatus to provide AR and/or VR images to a user.

### EXAMPLE EMBODIMENTS

Example 1: A display system comprising: a projector including a light source configured to output light at an exit pupil; and a retroreflector configured to redirect the light from the exit pupil toward a relayed pupil.

Example 2: The display system of Example 1, further comprising one or more pupil steering elements for steering the relayed pupil spatially within an eyebox of a user, wherein the relayed pupil corresponds to an eye pupil of the user.

Example 3: The display system of Example 1 or 2, further comprising a beamsplitter configured to further redirect the light reflected by the retroreflector such that the relayed pupil is separate from the exit pupil.

Example 4: The display system of Example 1, 2, or 3, further comprising a polarizer.

Example 5: The display system of Example 4, wherein the retroreflector is integrated with the polarizer.

Example 6: The display system of Example 4 or 5, wherein the retroreflector corresponds to an immersed surface such that the retroreflector and the polarizer form a monolithic structure.

Example 7: The display system of Example 4, 5, or 6, wherein the polarizer corresponds to at least one of a reflective polarizer, a 50/50 mirror, a quarter wave plate, or a linear polarizer.

Example 8: The display system of any of Examples 1-7, further comprising a waveguide having an input coupler.

Example 9: The display system of Example 8, wherein the relayed pupil corresponds to the input coupler.

Example 10: The display system of Example 8, 9, or 10, wherein the retroreflector is configured for light recycling with the input coupler.

Example 11: The display system of any of Examples 8-10, wherein: the waveguide has an output coupler; the retroreflector is positioned after the waveguide with respect to a light path from the projector; the light from the projector is configured to propagate through the input coupler to become coupled light and uncoupled light; the uncoupled light is configured to reflect off of the retroreflector and propagate through the input coupler to become coupled-uncoupled light and uncoupled-uncoupled light; and the coupled light and the coupled- uncoupled light are configured to propagate within the waveguide to the output coupler.

Example 12: The display system of any of Examples 1-11, wherein the retroreflector comprises at least one of a curved retroreflector array, a retroreflector array including one or more corner cube elements, or a retroreflector array including one or more spherical elements.

Example 13: The display system of any of Examples 1-12, wherein the projector corresponds to at least one of a scanning projector or a pixelated display with projection optics.

Example 14: A head-wearable display device comprising: a projector including a light source configured to output light at an exit pupil; and a retroreflector configured to redirect the light from the exit pupil toward a relayed pupil.

Example 15: The head-wearable display device of Example 14, further comprising a beamsplitter configured to further redirect the light reflected by the retroreflector such that the relayed pupil is separate from the exit pupil.

Example 16: The head-wearable display device of Example 15, further comprising a waveguide having an input coupler, wherein the relayed pupil corresponds to the input coupler.

Example 17: The head-wearable display device of Example 14, 15, or 16, further comprising a polarizer integrated with the retroreflector.

Example 18: The head-wearable display device of any of Examples 14-17, further comprising a waveguide having an input coupler, wherein the retroreflector is configured for light recycling with the input coupler.

Example 19: An artificial reality system comprising: at least one physical processor; physical memory coupled to the physical processor; and a display coupled to the physical processor and comprising: a projector including a light source configured to output light at an exit pupil; and a retroreflector configured to redirect the light from the exit pupil toward a relayed pupil.

Example 20: The artificial reality system of Example 19, wherein the display further comprises one or more pupil steering elements for steering the relayed pupil spatially within an eyebox of a user, wherein the relayed pupil corresponds to an eye pupil of the user.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

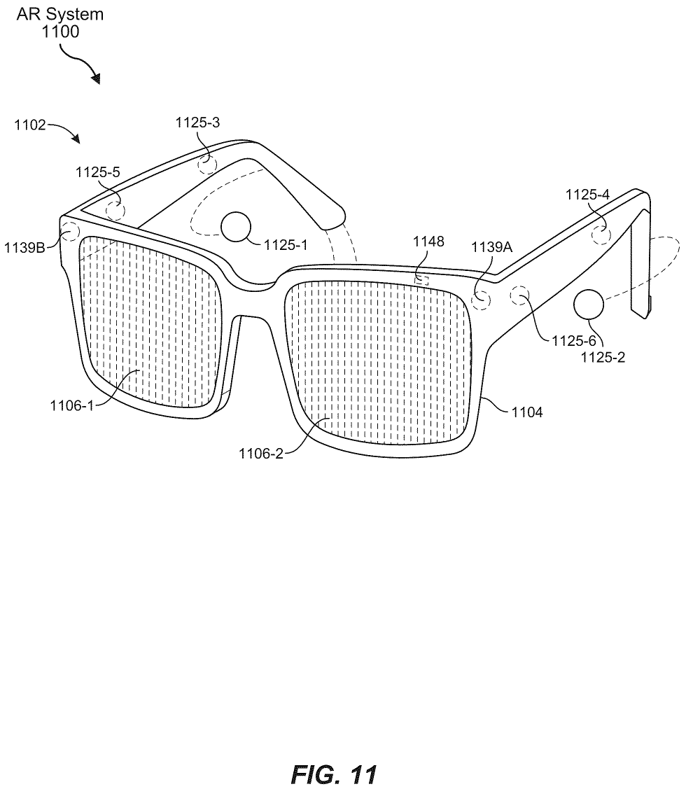

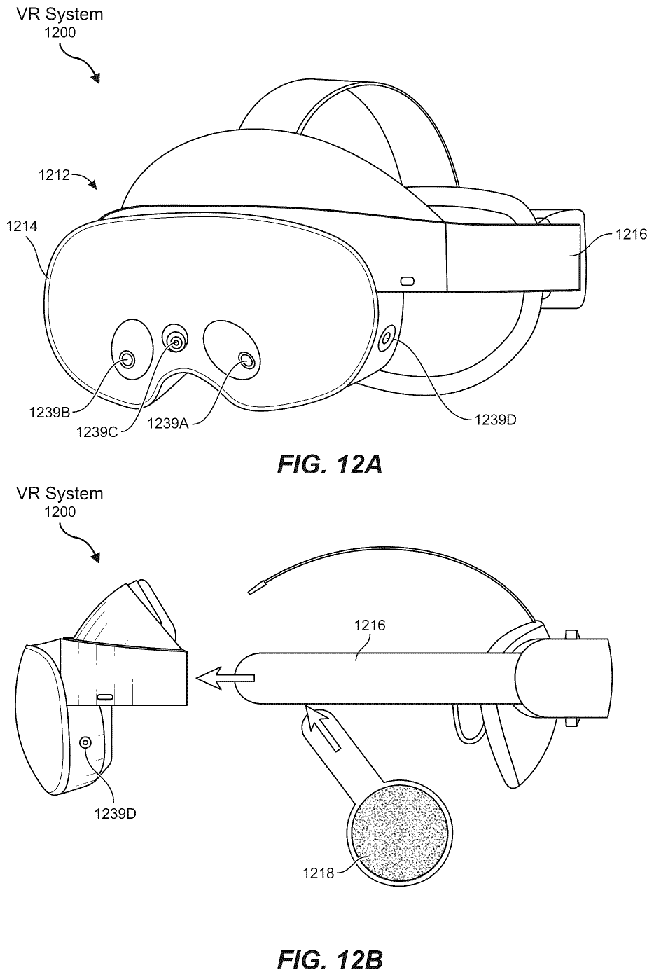

AR systems may be implemented in a variety of different form factors and configurations. Some AR systems may be designed to work without near-eye displays (NEDs). Other AR systems may include a NED that also provides visibility into the real world (such as, e.g., augmented-reality system 1100 in FIG. 11) or that visually immerses a user in an artificial reality (such as, e.g., virtual-reality system 1200 in FIGS. 12A and 12B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

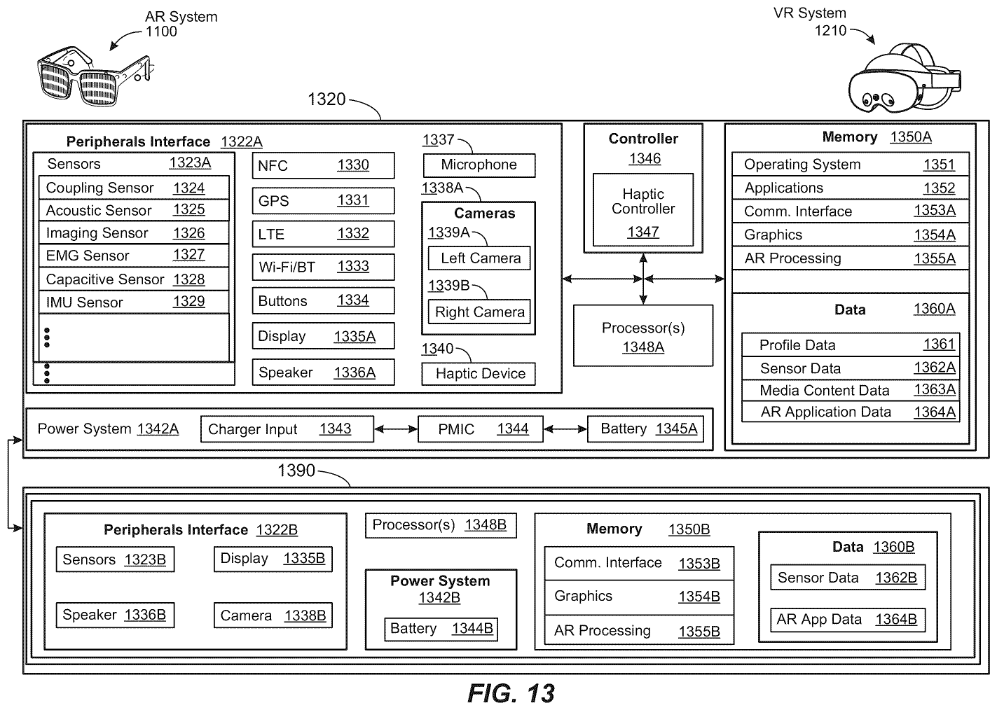

FIGS. 11 to 13 show example artificial-reality systems, which can be used as or in connection with any input device including a wearable device. In some embodiments, AR system 1100 includes an eyewear device 1102, as shown in FIG. 11. In some embodiments, VR system 1210 includes a head-mounted display (HMD) 1212, as shown in FIGS. 12A and 12B. In some embodiments, AR system 1100 and VR system 1210 can include one or more analogous components (e.g., components for presenting interactive artificial-reality environments, such as processors, memory, and/or presentation devices, including one or more displays and/or one or more waveguides), some of which are described in more detail with respect to FIG. 13. As described herein, a head-wearable device can include components of eyewear device 1102 and/or head-mounted display 1212. Some embodiments of head-wearable devices do not include any displays, including any of the displays described with respect to AR system 1100 and/or VR system 1210. While the example artificial-reality systems are respectively described herein as AR system 1100 and VR system 1210, either or both of the example AR systems described herein can be configured to present fully-immersive virtual-reality scenes presented in substantially all of a user's field of view or subtler augmented-reality scenes that are presented within a portion, less than all, of the user's field of view.

FIG. 11 show an example visual depiction of AR system 1100, including an eyewear device 1102 (which may also be described herein as augmented-reality glasses, and/or smart glasses). AR system 1100 can include additional electronic components that are not shown in FIG. 11, such as a wearable accessory device and/or an intermediary processing device, in electronic communication or otherwise configured to be used in conjunction with the eyewear device 1102. In some embodiments, the wearable accessory device and/or the intermediary processing device may be configured to couple with eyewear device 1102 via a coupling mechanism in electronic communication with a coupling sensor 1324 (FIG. 13), where coupling sensor 1324 can detect when an electronic device becomes physically or electronically coupled with eyewear device 1102. In some embodiments, eyewear device 1102 can be configured to couple to a housing 1390 (FIG. 13), which may include one or more additional coupling mechanisms configured to couple with additional accessory devices. The components shown in FIG. 11 can be implemented in hardware, software, firmware, or a combination thereof, including one or more signal-processing components and/or application-specific integrated circuits (ASICs).

Eyewear device 1102 includes mechanical glasses components, including a frame 1104 configured to hold one or more lenses (e.g., one or both lenses 1106-1 and 1106-2). One of ordinary skill in the art will appreciate that eyewear device 1102 can include additional mechanical components, such as hinges configured to allow portions of frame 1104 of eyewear device 1102 to be folded and unfolded, a bridge configured to span the gap between lenses 1106-1 and 1106-2 and rest on the user's nose, nose pads configured to rest on the bridge of the nose and provide support for eyewear device 1102, earpieces configured to rest on the user's ears and provide additional support for eyewear device 1102, temple arms configured to extend from the hinges to the earpieces of eyewear device 1102, and the like. One of ordinary skill in the art will further appreciate that some examples of AR system 1100 can include none of the mechanical components described herein. For example, smart contact lenses configured to present artificial reality to users may not include any components of eyewear device 1102.

Eyewear device 1102 includes electronic components, many of which will be described in more detail below with respect to FIG. 10. Some example electronic components are illustrated in FIG. 11, including acoustic sensors 1125-1, 1125-2, 1125-3, 1125-4, 1125-5, and 1125-6, which can be distributed along a substantial portion of the frame 1104 of eyewear device 1102. Eyewear device 1102 also includes a left camera 1139A and a right camera 1139B, which are located on different sides of the frame 1104. Eyewear device 1102 also includes a processor 1148 (or any other suitable type or form of integrated circuit) that is embedded into a portion of the frame 1104.

FIGS. 12A and 12B show a VR system 1210 that includes a head-mounted display (HMD) 1212 (e.g., also referred to herein as an artificial-reality headset, a head-wearable device, a VR headset, etc.), in accordance with some embodiments. As noted, some artificial-reality systems (e.g., AR system 1100) may, instead of blending an artificial reality with actual reality, substantially replace one or more of a user's visual and/or other sensory perceptions of the real world with a virtual experience.

HMD 1212 includes a front body 1214 and a frame 1216 (e.g., a strap or band) shaped to fit around a user's head. In some embodiments, front body 1214 and/or frame 1216 include one or more electronic elements for facilitating presentation of and/or interactions with an AR and/or VR system (e.g., displays, IMUs, tracking emitter or detectors). In some embodiments, HMD 1212 includes output audio transducers (e.g., an audio transducer 1218), as shown in FIG. 12B. In some embodiments, one or more components, such as the output audio transducer(s) 1218 and frame 1216, can be configured to attach and detach (e.g., are detachably attachable) to HMD 1212 (e.g., a portion or all of frame 1216, and/or audio transducer 1218), as shown in FIG. 12B. In some embodiments, coupling a detachable component to HMD 1212 causes the detachable component to come into electronic communication with HMD 1212.

FIGS. 12A and 12B also show that VR system 1210 includes one or more cameras, such as left camera 1239A and right camera 1239B, which can be analogous to left and right cameras 1139A and 1139B on frame 1104 of eyewear device 1102. In some embodiments, VR system 1210 includes one or more additional cameras (e.g., cameras 1239C and 1239D), which can be configured to augment image data obtained by left and right cameras 1239A and 1239B by providing more information. For example, camera 1239C can be used to supply color information that is not discerned by cameras 1239A and 1239B. In some embodiments, one or more of cameras 1239A to 1239D can include an optional IR cut filter configured to remove IR light from being received at the respective camera sensors.

FIG. 13 illustrates a computing system 1320 and an optional housing 1390, each of which show components that can be included in AR system 1100 and/or VR system 1210. In some embodiments, more or fewer components can be included in optional housing 1390 depending on practical restraints of the respective AR system being described.

In some embodiments, computing system 1320 can include one or more peripherals interfaces 1322A and/or optional housing 1390 can include one or more peripherals interfaces 1322B. Each of computing system 1320 and optional housing 1390 can also include one or more power systems 1342A and 1342B, one or more controllers 1346 (including one or more haptic controllers 1347), one or more processors 1348A and 1348B (as defined above, including any of the examples provided), and memory 1350A and 1350B, which can all be in electronic communication with each other. For example, the one or more processors 1348A and 1348B can be configured to execute instructions stored in memory 1350A and 1350B, which can cause a controller of one or more of controllers 1346 to cause operations to be performed at one or more peripheral devices connected to peripherals interface 1322A and/or 1322B. In some embodiments, each operation described can be powered by electrical power provided by power system 1342A and/or 1342B.

In some embodiments, peripherals interface 1322A can include one or more devices configured to be part of computing system 1320, such as wrist-wearable devices. For example, peripherals interface 1322A can include one or more sensors 1323A. Some example sensors 1323A include one or more coupling sensors 1324, one or more acoustic sensors 1325, one or more imaging sensors 1326, one or more EMG sensors 1327, one or more capacitive sensors 1328, one or more IMU sensors 1329, and/or any other types of sensors explained above or described with respect to any other embodiments discussed herein.

In some embodiments, peripherals interfaces 1322A and 1322B can include one or more additional peripheral devices, including one or more NFC devices 1330, one or more GPS devices 1331, one or more LTE devices 1332, one or more Wi-Fi and/or Bluetooth devices 1333, one or more buttons 1334 (e.g., including buttons that are slidable or otherwise adjustable), one or more displays 1335A and 1335B, one or more speakers 1336A and 1336B, one or more microphones 1337, one or more cameras 1338A and 1338B (e.g., including the left camera 1339A and/or a right camera 1339B), one or more haptic devices 1340, and/or any other types of peripheral devices defined above or described with respect to any other embodiments discussed herein.

AR systems can include a variety of types of visual feedback mechanisms (e.g., presentation devices). For example, display devices in AR system 1100 and/or VR system 1210 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 1335A and 1335B can be coupled to each of the lenses 1106-1 and 1106-2 of AR system 1100. Displays 1335A and 1335B may be coupled to each of lenses 1106-1 and 1106-2, which can act together or independently to present an image or series of images to a user. In some embodiments, AR system 1100 includes a single display 1335A or 1335B (e.g., a near-eye display) or more than two displays 1335A and 1335B. In some embodiments, a first set of one or more displays 1335A and 1335B can be used to present an augmented-reality environment, and a second set of one or more display devices 1335A and 1335B can be used to present a virtual-reality environment. In some embodiments, one or more waveguides are used in conjunction with presenting artificial-reality content to the user of AR system 1100 (e.g., as a means of delivering light from one or more displays 1335A and 1335B to the user's eyes). In some embodiments, one or more waveguides are fully or partially integrated into the eyewear device 1102. Additionally, or alternatively to display screens, some artificial- reality systems include one or more projection systems. For example, display devices in AR system 1100 and/or VR system 1210 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial- reality systems can also be configured with any other suitable type or form of image projection system. In some embodiments, one or more waveguides are provided additionally or alternatively to the one or more display(s) 1335A and 1335B.

Computing system 1320 and/or optional housing 1390 of AR system 1100 or VR system 1210 can include some or all of the components of a power system 1342A and 1342B. Power systems 1342A and 1342B can include one or more charger inputs 1343, one or more PMICs 1344, and/or one or more batteries 1345A and 1344B.

Memory 1350A and 1350B may include instructions and data, some or all of which may be stored as non-transitory computer-readable storage media within the memories 1350A and 1350B. For example, memory 1350A and 1350B can include one or more operating systems 1351, one or more applications 1352, one or more communication interface applications 1353A and 1353B, one or more graphics applications 1354A and 1354B, one or more AR processing applications 1355A and 1355B, and/or any other types of data defined above or described with respect to any other embodiments discussed herein.

Memory 1350A and 1350B also include data 1360A and 1360B, which can be used in conjunction with one or more of the applications discussed above. Data 1360A and 1360B can include profile data 1361, sensor data 1362A and 1362B, media content data 1363A, AR application data 1364A and 1364B, and/or any other types of data defined above or described with respect to any other embodiments discussed herein.

In some embodiments, controller 1346 of eyewear device 1102 may process information generated by sensors 1323A and/or 1323B on eyewear device 1102 and/or another electronic device within AR system 1100. For example, controller 1346 can process information from acoustic sensors 1125-1 and 1125-2. For each detected sound, controller 1346 can perform a direction of arrival (DOA) estimation to estimate a direction from which the detected sound arrived at eyewear device 1102 of R system 1100. As one or more of acoustic sensors 1325 (e.g., the acoustic sensors 1125-1, 1125-2) detects sounds, controller 1346 can populate an audio data set with the information (e.g., represented in FIG. 10 as sensor data 1362A and 1362B).

In some embodiments, a physical electronic connector can convey information between eyewear device 1102 and another electronic device and/or between one or more processors 1148, 1348A, 1348B of AR system 1100 or VR system 1210 and controller 1346. The information can be in the form of optical data, electrical data, wireless data, or any other transmittable data form. Moving the processing of information generated by eyewear device 1102 to an intermediary processing device can reduce weight and heat in the eyewear device, making it more comfortable and safer for a user. In some embodiments, an optional wearable accessory device (e.g., an electronic neckband) is coupled to eyewear device 1102 via one or more connectors. The connectors can be wired or wireless connectors and can include electrical and/or non-electrical (e.g., structural) components. In some embodiments, eyewear device 1102 and the wearable accessory device can operate independently without any wired or wireless connection between them.

In some situations, pairing external devices, such as an intermediary processing device with eyewear device 1102 (e.g., as part of AR system 1100) enables eyewear device 1102 to achieve a similar form factor of a pair of glasses while still providing sufficient battery and computation power for expanded capabilities. Some, or all, of the battery power, computational resources, and/or additional features of AR system 1100 can be provided by a paired device or shared between a paired device and eyewear device 1102, thus reducing the weight, heat profile, and form factor of eyewear device 1102 overall while allowing eyewear device 1102 to retain its desired functionality. For example, the wearable accessory device can allow components that would otherwise be included on eyewear device 1102 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 1102 standing alone. Because weight carried in the wearable accessory device can be less invasive to a user than weight carried in the eyewear device 1102, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 1100 and/or VR system 1210 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 12A and 12B show VR system 1210 having cameras 1239A to 1239D, which can be used to provide depth information for creating a voxel field and a two-dimensional mesh to provide object information to the user to avoid collisions.

In some embodiments, AR system 1100 and/or VR system 1210 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 1100 and/or VR system 1210, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

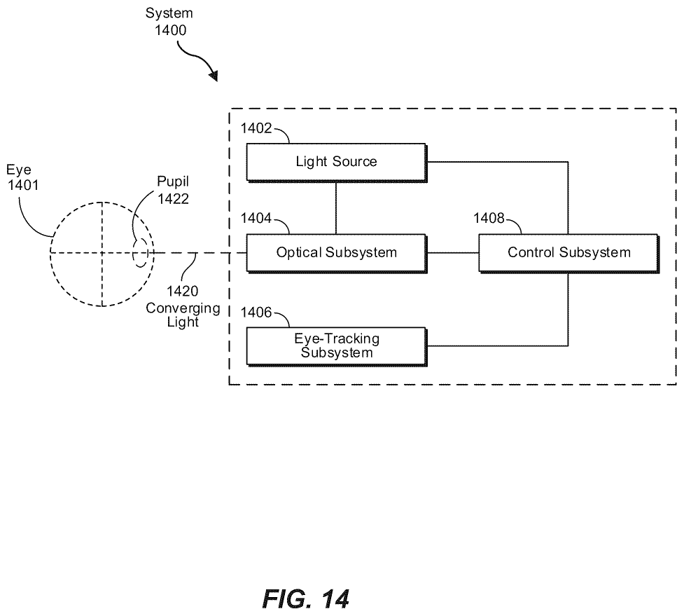

FIG. 14 is an illustration of an example system 1400 that incorporates an eye-tracking subsystem capable of tracking a user's eye(s). As depicted in FIG. 14, system 1400 may include a light source 1402, an optical subsystem 1404, an eye-tracking subsystem 1406, and/or a control subsystem 1408. In some examples, light source 1402 may generate light for an image (e.g., to be presented to an eye 1401 of the viewer). Light source 1402 may represent any of a variety of suitable devices. For example, light source 1402 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 1404 may receive the light generated by light source 1402 and generate, based on the received light, converging light 1420 that includes the image. In some examples, optical subsystem 1404 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 1420. Further, various mechanical couplings may serve to maintain the relative spacing and/or the orientation of the optical components in any suitable combination.

In one embodiment, eye-tracking subsystem 1406 may generate tracking information indicating a gaze angle of an eye 1401 of the viewer. In this embodiment, control subsystem 1408 may control aspects of optical subsystem 1404 (e.g., the angle of incidence of converging light 1420) based at least in part on this tracking information. Additionally, in some examples, control subsystem 1408 may store and utilize historical tracking information (e.g., a history of the tracking information over a given duration, such as the previous second or fraction thereof) to anticipate the gaze angle of eye 1401 (e.g., an angle between the visual axis and the anatomical axis of eye 1401). In some embodiments, eye-tracking subsystem 1406 may detect radiation emanating from some portion of eye 1401 (e.g., the cornea, the iris, the pupil, or the like) to determine the current gaze angle of eye 1401. In other examples, eye-tracking subsystem 1406 may employ a wavefront sensor to track the current location of the pupil.

Any number of techniques can be used to track eye 1401. Some techniques may involve illuminating eye 1401 with infrared light and measuring reflections with at least one optical sensor that is tuned to be sensitive to the infrared light. Information about how the infrared light is reflected from eye 1401 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 1406 may be digitized (i.e., converted to an electronic signal). Further, the sensor may transmit a digital representation of this electronic signal to one or more processors (for example, processors associated with a device including eye-tracking subsystem 1406). Eye-tracking subsystem 1406 may include any of a variety of sensors in a variety of different configurations. For example, eye-tracking subsystem 1406 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 1406 to track the movement of eye 1401. In another example, these processors may track the movements of eye 1401 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 1406 may be programmed to use an output of the sensor(s) to track movement of eye 1401. In some embodiments, eye-tracking subsystem 1406 may analyze the digital representation generated by the sensors to extract eye rotation information from changes in reflections. In one embodiment, eye-tracking subsystem 1406 may use corneal reflections or glints (also known as Purkinje images) and/or the center of the eye's pupil 1422 as features to track over time.

In some embodiments, eye-tracking subsystem 1406 may use the center of the eye's pupil 1422 and infrared or near-infrared, non-collimated light to create corneal reflections. In these embodiments, eye-tracking subsystem 1406 may use the vector between the center of the eye's pupil 1422 and the corneal reflections to compute the gaze direction of eye 1401. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 1406 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 1401 may act as a retroreflector as the light reflects off the retina, thereby creating a bright pupil effect similar to a red-eye effect in photography. If the illumination source is offset from the optical path, then the eye's pupil 1422 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 1408 may control light source 1402 and/or optical subsystem 1404 to reduce optical aberrations (e.g., chromatic aberrations and/or monochromatic aberrations) of the image that may be caused by or influenced by eye 1401. In some examples, as mentioned above, control subsystem 1408 may use the tracking information from eye-tracking subsystem 1406 to perform such control. For example, in controlling light source 1402, control subsystem 1408 may alter the light generated by light source 1402 (e.g., by way of image rendering) to modify (e.g., pre-distort) the image so that the aberration of the image caused by eye 1401 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

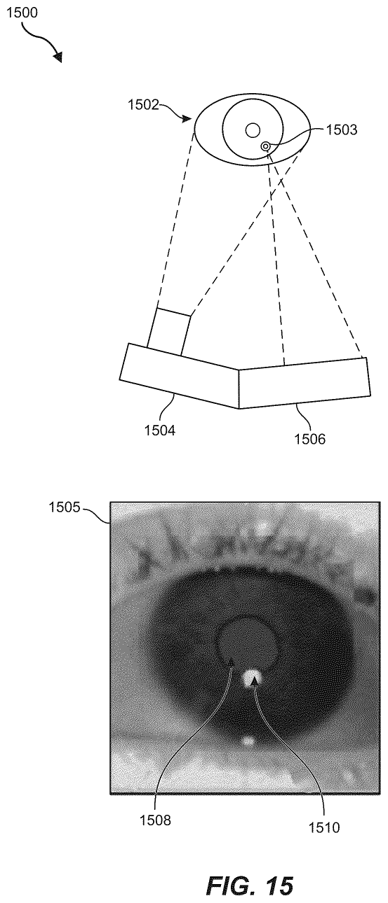

FIG. 15 is a more detailed illustration of various aspects of the eye-tracking subsystem illustrated in FIG. 14. As shown in this figure, an eye-tracking subsystem 1500 may include at least one source 1504 and at least one sensor 1506. Source 1504 generally represents any type or form of element capable of emitting radiation. In one example, source 1504 may generate visible, infrared, and/or near-infrared radiation. In some examples, source 1504 may radiate non-collimated infrared and/or near-infrared portions of the electromagnetic spectrum towards an eye 1502 of a user. Source 1504 may utilize a variety of sampling rates and speeds. For example, the disclosed systems may use sources with higher sampling rates in order to capture fixational eye movements of a user's eye 1502 and/or to correctly measure saccade dynamics of the user's eye 1502. As noted above, any type or form of eye-tracking technique may be used to track the user's eye 1502, including optical-based eye-tracking techniques, ultrasound-based eye-tracking techniques, etc.

Sensor 1506 generally represents any type or form of element capable of detecting radiation, such as radiation reflected off the user's eye 1502. Examples of sensor 1506 include, without limitation, a charge coupled device (CCD), a photodiode array, a complementary metal-oxide-semiconductor (CMOS) based sensor device, and/or the like. In one example, sensor 1506 may represent a sensor having predetermined parameters, including, but not limited to, a dynamic resolution range, linearity, and/or other characteristic selected and/or designed specifically for eye tracking.

As detailed above, eye-tracking subsystem 1500 may generate one or more glints. As detailed above, a glint 1503 may represent reflections of radiation (e.g., infrared radiation from an infrared source, such as source 1504) from the structure of the user's eye. In various embodiments, glint 1503 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 15 shows an example image 1505 captured by an eye-tracking subsystem, such as eye-tracking subsystem 1500. In this example, image 1505 may include both the user's pupil 1508 and a glint 1510 near the same. In some examples, pupil 1508 and/or glint 1510 may be identified using an artificial-intelligence-based algorithm, such as a computer-vision-based algorithm. In one embodiment, image 1505 may represent a single frame in a series of frames that may be analyzed continuously in order to track the eye 1502 of the user. Further, pupil 1508 and/or glint 1510 may be tracked over a period of time to determine a user's gaze.

In one example, eye-tracking subsystem 1500 may be configured to identify and measure the inter-pupillary distance (IPD) of a user. In some embodiments, eye-tracking subsystem 1500 may measure and/or calculate the IPD of the user while the user is wearing the artificial reality system. In these embodiments, eye-tracking subsystem 1500 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing on different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images is presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 1400 and/or eye-tracking subsystem 1500 may be incorporated into any of the augmented-reality systems in and/or virtual-reality systems described herein in to enable these systems to perform various eye-tracking tasks (including one or more of the eye-tracking operations described herein).

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules/components described herein may transform data, physical devices, and/or representations of physical devices from one form to another. Additionally or alternatively, one or more of the modules/components recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A display system comprising:
a projector including a light source configured to output light at an exit pupil; and
a retroreflector configured to redirect the light from the exit pupil toward a relayed pupil.

2. The display system of claim 1, further comprising one or more pupil steering elements for steering the relayed pupil spatially within an eyebox of a user, wherein the relayed pupil corresponds to an eye pupil of the user.

3. The display system of claim 1, further comprising a beamsplitter configured to further redirect the light reflected by the retroreflector such that the relayed pupil is separate from the exit pupil.

4. The display system of claim 1, further comprising a polarizer.

5. The display system of claim 4, wherein the retroreflector is integrated with the polarizer.

6. The display system of claim 5, wherein the retroreflector corresponds to an immersed surface such that the retroreflector and the polarizer form a monolithic structure.

7. The display system of claim 4, wherein the polarizer corresponds to at least one of a reflective polarizer, a 50/50 mirror, a quarter wave plate, or a linear polarizer.

8. The display system of claim 1, further comprising a waveguide having an input coupler.

9. The display system of claim 8, wherein the relayed pupil corresponds to the input coupler.

10. The display system of claim 8, wherein the retroreflector is configured for light recycling with the input coupler.

11. The display system of claim 10, wherein:
the waveguide has an output coupler;
the retroreflector is positioned after the waveguide with respect to a light path from the projector;
the light from the projector is configured to propagate through the input coupler to become coupled light and uncoupled light;
the uncoupled light is configured to reflect off of the retroreflector and propagate through the input coupler to become coupled-uncoupled light and uncoupled-uncoupled light; and
the coupled light and the coupled-uncoupled light are configured to propagate within the waveguide to the output coupler.

12. The display system of claim 1, wherein the retroreflector comprises at least one of a curved retroreflector array, a retroreflector array including one or more corner cube elements, or a retroreflector array including one or more spherical elements.

13. The display system of claim 1, wherein the projector corresponds to at least one of a scanning projector or a pixelated display with projection optics.

14. A head-wearable display device comprising:
a projector including a light source configured to output light at an exit pupil; and
a retroreflector configured to redirect the light from the exit pupil toward a relayed pupil.

15. The head-wearable display device of claim 14, further comprising a beamsplitter configured to further redirect the light reflected by the retroreflector such that the relayed pupil is separate from the exit pupil.

16. The head-wearable display device of claim 15, further comprising a waveguide having an input coupler, wherein the relayed pupil corresponds to the input coupler. 17 The head-wearable display device of claim 14, further comprising a polarizer integrated with the retroreflector.

18. The head-wearable display device of claim 14, further comprising a waveguide having an input coupler, wherein the retroreflector is configured for light recycling with the input coupler. 19 An artificial reality system comprising:
at least one physical processor;
physical memory coupled to the physical processor; and
a display coupled to the physical processor and comprising:
a projector including a light source configured to output light at an exit pupil; and
a retroreflector configured to redirect the light from the exit pupil toward a relayed pupil.

20. The artificial reality system of claim 19, wherein the display further comprises one or more pupil steering elements for steering the relayed pupil spatially within an eyebox of a user, wherein the relayed pupil corresponds to an eye pupil of the user.
